(19) United States
(12) Patent Application Publication
(10) Pub. No.: US 2011/0227781 A1
(43) Pub. Date: Sep. 22, 2011

(54) METHOD AND APPARATUS FOR DETECTING ROAD-EDGES

(75) Inventor: Naoki NITANDA, Anjo-shi (JP)

(73) Assignee: DENSO CORPORATION, Kariya-city (JP)

(21) Appl. No.: 13/048,953

(22) Filed: Mar. 16, 2011

(30) Foreign Application Priority Data
Mar. 17, 2010 (JP) 2010-060744

(51) Int. Cl. G01S 13/00

(52) U.S. Cl. 342/70

(57) ABSTRACT

An on-vehicle apparatus detects at least one of right and left edges of a road on and along which a vehicle travels. In the apparatus, acquired is information indicative of a plurality of detection points which are given as a plurality of candidates for the edges of the road viewed forward from the vehicle. Further acquired is information indicative of behaviors of the vehicle. A calculating member calculates, based on the acquired information, every detection point, a plurality of passing positions each indicating a position of each of the detection points to a position of the vehicle provided that the vehicle travels to a position on the road which is located right beside each of the detection points. A road edge obtaining member obtains the edges of the road based on the plurality of passing positions calculated.

### CROSS-REFERENCE TO RELATED APPLICATION

This application is based on and claims the benefit of priority from earlier Japanese Patent Application No. 2010-060744 filed Mar. 17, 2010, the description of which is incorporated herein by reference.

### BACKGROUND OF THE INVENTION

1. Technical Field of the Invention

The present invention relates to a method and apparatus for detecting road-edges, which detects side edges (road edges) of a road on which the vehicle equipped with the present apparatus travels.

2. Related Art

A technique for detecting a road edge has been known. As an example of such a technique, JP-B-4100269 discloses a road-edge detection apparatus. This road-side detection system makes use of the behaviors of the vehicle installing the system, and the positions of targets which are assumed to be located on a road edge. Specifically, in this system, a positional relationship (passing position) between the vehicle installing the system and each of the targets is estimated for the time point when the vehicle passes right beside the target, based on the behaviors of the vehicle and the target position. Then, the road edge is detected from the results of the estimation of the positional relationship.

However, in the road-edge detection apparatus mentioned above, a road edge is likely to be erroneously detected if a detected target is not located on a road edge. Therefore, this road-edge detection apparatus requires an additional process of determining that the target is located on a road edge. In fact, however, it is difficult to reliably detect whether or not a target is located on a road edge. Thus, the road-edge detection apparatus mentioned above has suffered from the problem of low accuracy of detecting a road edge.

### SUMMARY OF THE INVENTION

The present invention has been made in light of the problem set forth above and has as its object to provide a method and apparatus for detecting road edge(s), which is installed in a vehicle for the detection of the edges of a road on which the vehicle travels, where the method and apparatus are able to enhance the accuracy of detecting the road edges.

As one aspect of the present invention, there is provided an apparatus for detecting at least one of right and left edges of a road on and along which a vehicle travels, the apparatus being mounted on the vehicle. The apparatus comprises first acquiring means for acquiring information indicative of a plurality of detection points which are given as a plurality of candidates for the edges of the road viewed forward from the vehicle; second acquiring means for acquiring information indicative of behaviors of the vehicle; calculating means for calculating, based on the information acquired by the first and second acquiring means, every detection point, a plurality of passing positions each indicating a position of each of the detection points to a position of the vehicle provided that the vehicle travels to a position on the road which is located right beside each of the detection points; and road edge obtaining means for obtaining the edges of the road based on the plurality of passing positions calculated.

In the above configuration, “the position on the road which is located right beside each of the detection points” is defined as a position where a vehicle's predetermined part reaches a line connecting each detection position and the center of a road curvature. For example, the “vehicle's predetermined part is a vehicle's part where the first acquiring means is mounted in the vehicle.

According to the apparatus, each road edge is detected based on a plurality of passing positions. Accordingly, compared to a configuration in which a road edge is detected based on a sole passing position, the accuracy of detecting a road edge is enhanced. In the present embodiment, the term “road edge” refers to one of the left and right road edges and the term “road edges” refers to both of the left and right road edges.

Specifically, the road-end detecting means may simply use a mean value of a plurality of passing positions. In this case, the mean value may be of the plurality of passing positions excluding the maximum and minimum values. Alternatively, a median value of a plurality of passing positions may be used.

It is preferred that the road edge obtaining means comprises sorting means for sorting the calculated passing positions into a plurality of groups of passing positions every unit distance predetermined depending on distances between the vehicle and the detection points, and edge specifying means for specifying, as positions of the edges of the road to the vehicle, a representative passing position representative of one among the groups of passing positions, the largest number of passing positions are sorted into the representative one group of passing positions.

Detection points may include those which are not of road edges but of other objects, such as preceding vehicles or buildings, than the road edges. In such a case, with the configuration of the present invention, the relative distances between the vehicle and the individual detection points of other objects are likely to differ from each other when the vehicle is assumed to have moved to the positions right beside these detection points of other objects. Accordingly, the passing positions based on these detection points of other objects are likely to be sorted into different groups. Thus, the detection points not indicating road edges are unlikely to be sorted into “a group having a maximum number of passing positions”, and thus are likely to be removed from the detection points indicating the road edges.

On the other hand, detection points indicating road edges are detected from along the shape of the road. Accordingly, when the vehicle is assumed to have moved to the positions right beside these detection points, these detection points will be closely located with each other. Therefore, the passing positions based on these detection points are likely to be sorted into the same group which is defined as indicating the location of a road edge.

Thus, according to the apparatus, the accuracy of detecting a road edge is enhanced, irrespective of the inclusion of the detection points indicating objects other than road edges.

It is also preferred that the edge specifying means is configured to specify, as the positions of the edges of the road, the representative passing position on each of the right and left sides to the vehicle.

According to the apparatus, the road edges of both of the left and right sides of the vehicle can be detected. Therefore, the accuracy of detecting a road edge is more enhanced.

Still preferably, the first acquiring means is configured to acquire the information indicative of the plurality of detection points that are detected by intermittently radiating an electromagnetic wave ahead of the vehicle to scan a given spatial range ahead and viewed from the vehicle and receiving a reflected electromagnetic wave thereof, the calculating means comprises travel amount calculating means for calculating, every time when the electromagnetic wave is transmitted, an amount of travel of the vehicle during a given interval of time including at least a time necessary from transmitting the electromagnetic wave to receiving the reflected electromagnetic wave, based on the acquired information indicative of the behavior of the vehicle, and position correcting means for correcting the positions of the detection points depending on the amounts of travel of the vehicle calculated by the travel amount calculating means, and the road edge obtaining means is configured to obtain the edges of the road based on the corrected positions of the respective detection points.

For example, the apparatus may be used with a laser radar which is configured to obtain detection points by scanning a predetermined region in the forward direction of the vehicle while intermittently applying electromagnetic waves to the region and by receiving the reflected waves. Being used with a laser radar having such a configuration, the apparatus is able to correct the delay time caused in the detection and therefore the accuracy of detecting a road edge is maintained.

### BRIEF DESCRIPTION OF THE DRAWINGS

In the accompanying drawings:

FIG. 1 is a schematic block diagram illustrating a configuration of a recognition system to which an embodiment of the present invention is applied;

FIG. 2A is a flow diagram illustrating a road-edge location recognizing process, according to the embodiment;

FIG. 2B is a flow diagram illustrating a range-data generating process, according to the embodiment;

FIGS. 3A and 3B are schematic diagrams illustrating a process of correcting a detection point, according to the embodiment;

FIG. 4A is a flow diagram illustrating a histogram generating process, according to the embodiment;

FIG. 4B is a flow diagram illustrating a road-edge location recognizing process, according to the embodiment;

FIGS. 5A and 5B are schematic diagrams illustrating a process of estimating positions of detection points and generating a histogram, according to the embodiment;

FIG. 6 is an explanatory diagram illustrating an example of calculation in estimating the position of a detection point, according to the embodiment; and

FIG. 7 is an explanatory diagram illustrating an outline and effects of the present embodiment.

### DETAILED DESCRIPTION OF THE PREFERRED EMBODIMENTS

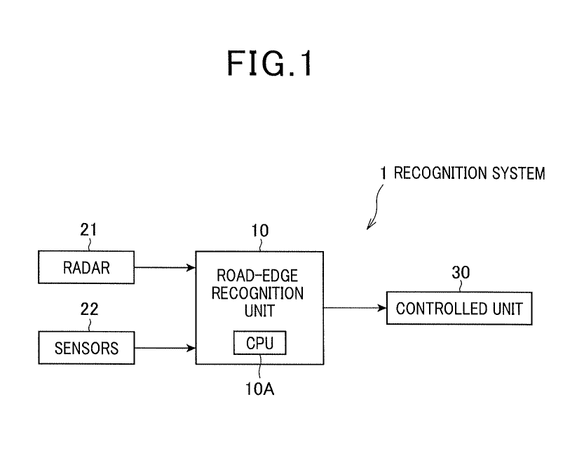

With reference to FIGS. 1 to 7, hereinafter is described an embodiment of the present invention.

FIG. 1 is a schematic block diagram illustrating a recognition system 1 to which an embodiment of the present invention is applied. The recognition system 1 is installed in a vehicle, such as a motor car, and has a function of detecting road edges, i.e. left and right edges, of the road on which the vehicle equipped with the recognition system 1 (hereinafter referred to as “the vehicle concerned” or just as “the vehicle”) travels. Specifically, as shown in FIG. 1, the recognition system 1 includes a road-edge recognition unit 10 (, which provides an apparatus for detecting road edge(s)), a radar 21, sensors 22 and a controlled unit 30. In the road-edge recognition 10, an algorism which realizes a method for detecting road edge(s) is installed in advance.

In the present embodiment, the radar 21 is mounted at a front part of the vehicle, such as a vehicle front window or a vehicle front grill. Of course, the radar 21 may be mounted at a vehicle's part different from its front part. The radar 21 is configured as a laser radar. The radar 21 scans a predetermined region in a traveling direction of the vehicle (forward direction in the present embodiment), intermittently applying laser beams, i.e. electromagnetic waves, to the region, and receives the reflected waves (reflected light) to detect targets, as detection points, which are located in the forward direction of the vehicle.

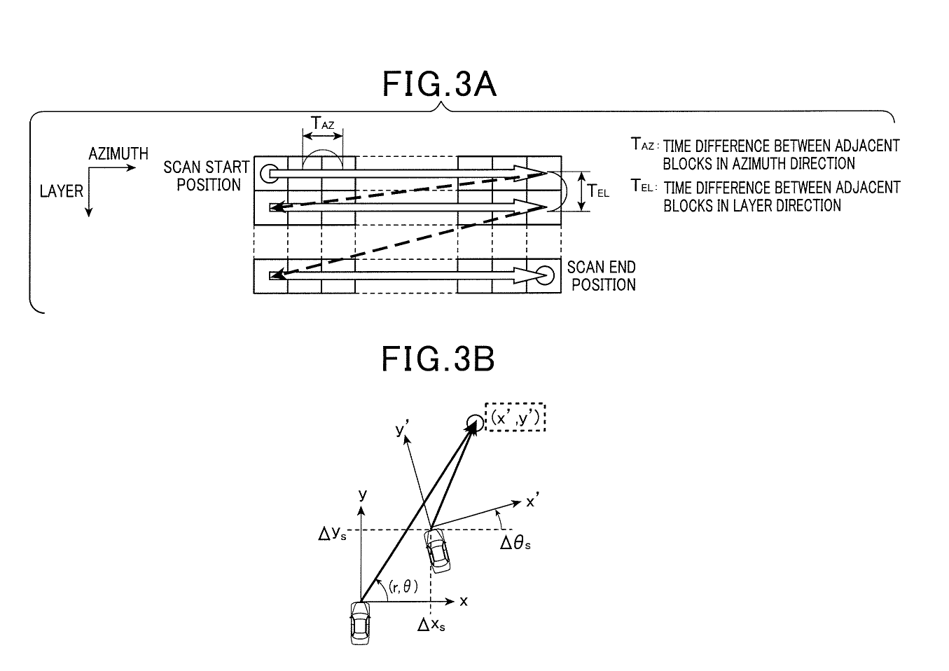

Specifically, the radar 21 applies laser beams from an upper-left corner to an upper-right corner, i.e. applies laser beams horizontally rightward, of the predetermined region that has been set as a region for applying laser beams. In applying laser beams to the predetermined region, the radar 21 changes the range of the horizontally-rightward application of the laser beams, while intermittently applying laser beams to the region at even intervals (even angles). When the laser beams reach the upper-right corner, the radar 21 changes the range of the horizontally-rightward application of the laser beams, to a lower range located lower than the upper-left corner by a predetermined angle, and resumes application of the laser beams (see FIG. 3A).

Repeating this action, the radar 21 sequentially applies the laser beams to the entire predetermined region. The radar 21 detects the positions of targets (detection points) every time the laser beams are applied, based on the timings of detecting the reflected waves and the directions of applying the laser beams. Upon completing scanning of the entire region, the radar 21 transmits position data of the detection points to the road-edge recognition unit 10.

The radar 21 is able to detect not only three-dimensional objects, such as guardrails, reflectors, wall surfaces and trees, but also planar objects, such as white lines and paints on the road. In detecting planar objects by the radar 21, a threshold may be set to a reflection intensity of a reflected wave and objects whose reflection intensity is larger than the threshold may be selected.

In the present embodiment, position data of a detection point is ensured not to be generated when laser beams are applied in a direction disabling reception of the reflected waves, such as toward the sky. This is for mitigating the processing load caused in a range-data generating process which will be described later. In this configuration, data is transmitted to the road-edge recognition unit 10 when the predetermined region has been scanned, the data containing information on the positions of detection points, which are equal to the number of detection points (constant N described later) received with the reflected waves.

The radar 21 is configured so that the above process for detecting detection points is periodically (e.g., every 100 ms) performed.

The sensors 22 are each configured as a well-known sensor that outputs the results of detection of the behaviors of the vehicle concerned. Specific examples of the sensors 22 may include a vehicle speed sensor that detects the traveling speed of the vehicle, a yaw rate sensor that detects an angular rate of turn of the vehicle, and an acceleration sensor that detects acceleration applied to the vehicle. The sensors 22 transmit the results of detection of the behaviors of the vehicle to the road-edge recognition unit 10.

The road-edge recognition unit 10 is configured as a well-known microcomputer that includes a CPU 10A, a ROM and a RAM (ROM and RAM are not shown), to perform various processes based on the program stored in the ROM or the program loaded on the RAM. One of the processes performed by the road-edge recognition unit 10 is a road-edge location recognizing process that will be described later. In performing the various processes, the road-edge recognition unit 10 uses the results of detection acquired from the radar 21 and the sensors 22.

The road-edge recognition unit 10 recognizes road edges and uses the information on the recognized road edges to recognize the road width, the position of the vehicle in relation to the road edges, the location (range) of the road in a distance, and the like. Then, the road-edge recognition unit 10 outputs the information to the controlled unit 30.

The controlled unit 30 is configured as a well-known microcomputer that includes a CPU, a ROM and a RAM (not shown) to perform various controls upon reception of the information from the road-edge recognition unit 10. For example, the various controls include automatic cruising under which the accelerator, the brake and the steering wheel, for example, of the vehicle are automatically controlled, and drive assist under which warning is given to the driver or guidance is given to the driver for performing predetermined operations.

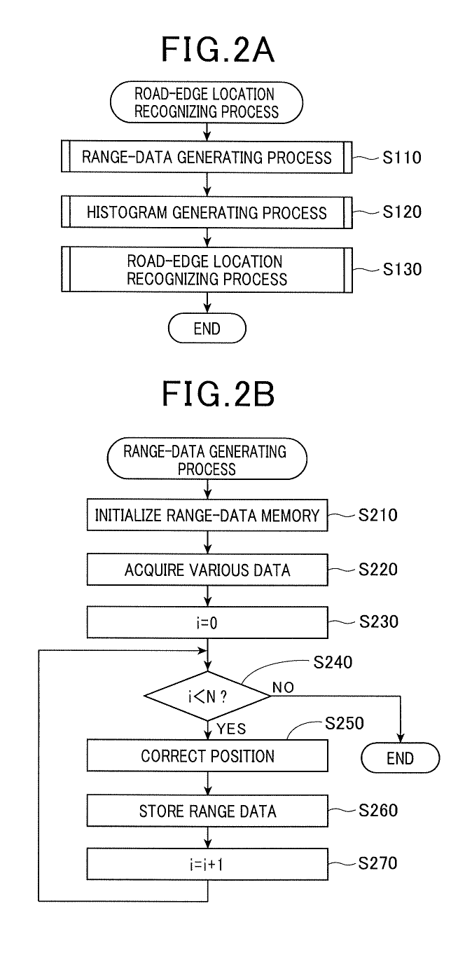

Referring now to FIGS. 2A and 2B as well as the subsequent drawings, hereinafter will be described processes for detecting road edges. FIG. 2A is a flow diagram illustrating a road-edge location recognizing process performed by the road-edge recognition unit 10. FIG. 2B is a flow diagram illustrating a range-data generating process performed in the road-edge location recognizing process.

The road-edge location recognizing process is started, for example, upon application of power of the vehicle concerned, and then periodically (e.g., every 100 ms) repeated. Specifically, as shown in FIG. 2A, the following processes are sequentially performed:

Range-data generating process in which the results of detection of the radar 21 are acquired to generate range data including new detection points with delay caused by scanning being corrected (step S110). Histogram generating process in which a histogram is generated according to positions of detection points at the time point when the vehicle is assumed to have moved to “the position right beside each of the detection points” (step S120). In the present embodiment, “the position right beside each of the detection points” is defined as a position where the mounted position of the radar 21 in the vehicle reaches a line connecting each detection position and the center of a road curvature. Of course, “the position right beside each of the detection points” may be defined using the longitudinal center of a vehicle, instead of using the mounted position at which the radar 21 is mounted in the vehicle. Furthermore, road-edge location recognizing process in which road edge locations are detected based on the histogram (step S130: road-edge obtaining means).

As shown in FIG. 2B, in the range-data generating process, range data in the RAM is initialized (step S210) and various data are acquired (step S220: detection point acquiring means, behavior acquiring means). The data acquired in the process of S220 include data on the results of detection of detection points from the radar 21, and data on the results of detection of the vehicle behaviors from the sensors 22.

Subsequently, a process of correcting delay caused by the scanning of the radar 21 is performed (steps S230 to S270). Specifically, a variable i is reset (set to zero) (step S230), followed by comparison of the variable i with the constant N (step S240). The constant N indicates the number of total detection points that have been detected by one scanning of the radar 21.

If the variable i is equal to or more than the constant N (NO at step S240), it means that correction of the positions of all the detection points has been completed, and thus the present process is ended. If the variable i is less than the constant N (YES at step S240), an i^{th} detection point is selected to perform the process of correcting the position of the i^{th} detection point (step S250: position correcting means).

Specifically, in this process, a travel distance of the vehicle from each time point of applying laser beams up to a time point of ending scanning is calculated based on the behaviors of the vehicle. Then, the position of each acquired detection point is corrected by an amount equal to the calculated travel distance of the vehicle. This process is specifically described referring to FIGS. 3A and 3B. FIGS. 3A and 3B are schematic diagrams illustrating a process of correcting the position of a detection point.

As shown in FIG. 3A, the entire region to which laser beams are applied by the radar 21 is divided into matrix blocks. In each horizontal row of blocks, one scanning is performed with the application of laser beams. Each of the blocks is numbered. In the horizontal direction, the blocks are sequentially numbered from the left to the right and these numbers are referred to “azimuth numbers”. In the vertical direction, the blocks are sequentially numbered from the top to the bottom and these numbers are referred to “layer numbers”.

In this configuration, each of the blocks to which laser beams are applied by the radar 21 is defined by an azimuth number and a layer number. It should be appreciated that the radar 21 applies laser beams to the blocks at a predetermined time interval.

On this premise, a time difference (time delay) from when laser beams are applied to a block having a certain azimuth number and a certain layer number until when laser beams are applied to a position where scanning is ended (scanning end position) is expressed by the following Formula (1).

ΔT=T_{AZ}×(total number of azimuth blocks−azimuth number)+T_{EL}×(total number of layer blocks−layer number) Formula (1)

where ΔT is a time delay caused before the time point when laser beams are applied to a position of ending scanning, T_{AZ} is a time difference from when laser beams are applied to a block having a certain azimuth number until when laser beams are applied to the adjacent block having a certain azimuth number (but having the same layer number), T_{EL} is a time difference from when laser beams are applied to a block having a certain layer number until when laser beams are applied to the adjacent block having a certain layer number (but having the same azimuth number).

Let us assume, as shown in FIG. 3B, that (x, y) is a coordinate (orthogonal coordinate) indicating the position of a detection point before correction, (x′, y′) is a coordinate (orthogonal coordinate) indicating the position of a detection point after correction, (r, θ) is a coordinate (polar coordinate) indicating the position of a detection point before correction as viewed from the vehicle, and (r′, θ′) is a coordinate (polar coordinate) indicating the position of a detection point after correction as viewed from the vehicle. Then, as shown in FIG. 3B, the coordinate (x′, y′) indicating the position of a detection point after correction is calculated by the following Formula (2).

$$\begin{matrix}( \begin{matrix}{x}^{′} \\ {y}^{′}\end{matrix} ) = ( \begin{matrix}cos Δ {θ}_{s} & sin Δ {θ}_{s} \\ - sin Δ {θ}_{s} & cos Δ {θ}_{s}\end{matrix} ) ( \begin{matrix}x - Δ {x}_{s} \\ y - Δ {y}_{s}\end{matrix} ) \\ = ( \begin{matrix}cos Δ {θ}_{s} & sin Δ {θ}_{s} \\ - sin Δ {θ}_{s} & cos Δ {θ}_{s}\end{matrix} ) ( \begin{matrix}r cos θ - Δ {x}_{s} \\ r sin θ - Δ {y}_{s}\end{matrix} )\end{matrix} \qquad Formula ( 2 )$$

where Δxₛ=x′−x, Δyₛ=y′−y and Δθₛ=θ′−θ. It should be appreciated that Δxₛ, Δyₛ and Δθₛ are calculated from the behaviors of the vehicle concerned (speed and yaw rate of the vehicle).

Since the radar 21 of the present embodiment has a comparatively high resolution, it is effective to perform the process of correcting the position of a detection point to achieve higher accuracy. In other words, if a detection system having a low resolution is used instead of the radar 21, the position of a detection point can no longer be accurately detected. In this case, it is difficult to enjoy the effects that would be obtained from the correction process described above.

After completing the process of correcting delay, the range data (data of a detection point after correction) regarding the i^{th} detection point are stored in an area in the RAM for storing range data (step S260). Then, the variable i is incremented (step S270) and control returns to step S240.

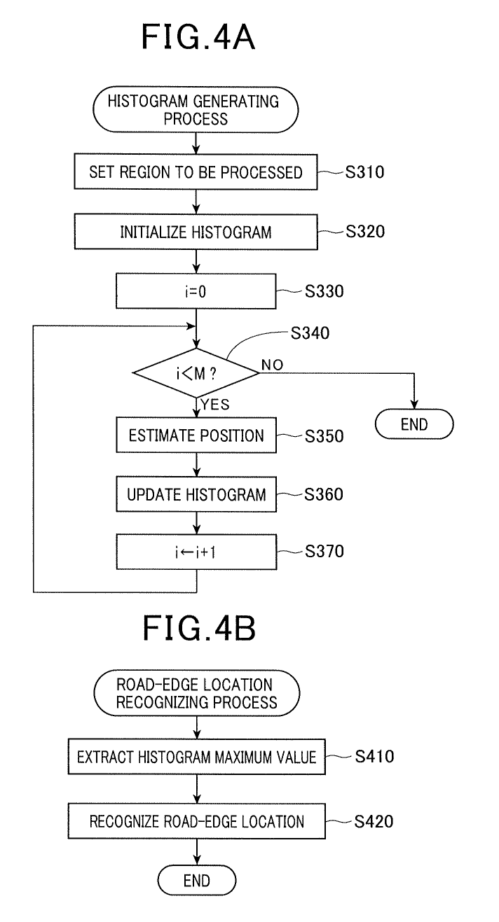

Referring now to the flow diagrams illustrated in FIGS. 4A and 4B, a histogram generating process is described. In the histogram generating process, a region to be processed is set, first (step S310). The “region to be processed” here refers to a range that extends in the left and right directions with reference to the forward direction of the vehicle but falls within a predetermined angle (within about 45 degrees). Specifically, the region to be processed is indicated by a range of L extending forward (e.g., 50 m) from a borderline between the region to be processed and the region out of the region to be processed. Considering the detection capability of the radar 21, the region to be processed is set in a comparatively short-distance region. This is because, if a long-distance region is included, the shape of the road is very likely to change from a curved line to a straight line or vice versa, making it difficult to detect road edges.

In the present process, of the range data stored in the RAM, only those which are included in the region to be processed are extracted.

Subsequently, the area in the RAM for storing the histogram is initialized (step S320) and the variable i is reset (step S330). Then, the variable i and a constant M is compared (step S340). The constant M here refers to the total number of range data included in the region to be processed.

If the variable i is equal to or more than the constant M (NO at step S340), it means that sorting of all the detection points in the histogram has been completed and thus the present process is ended. If the variable i is less than the constant M (YES at step S340), the i^{th} detection point is selected, followed by a process of estimating the position of the i^{th} detection point (step S350: calculating means).

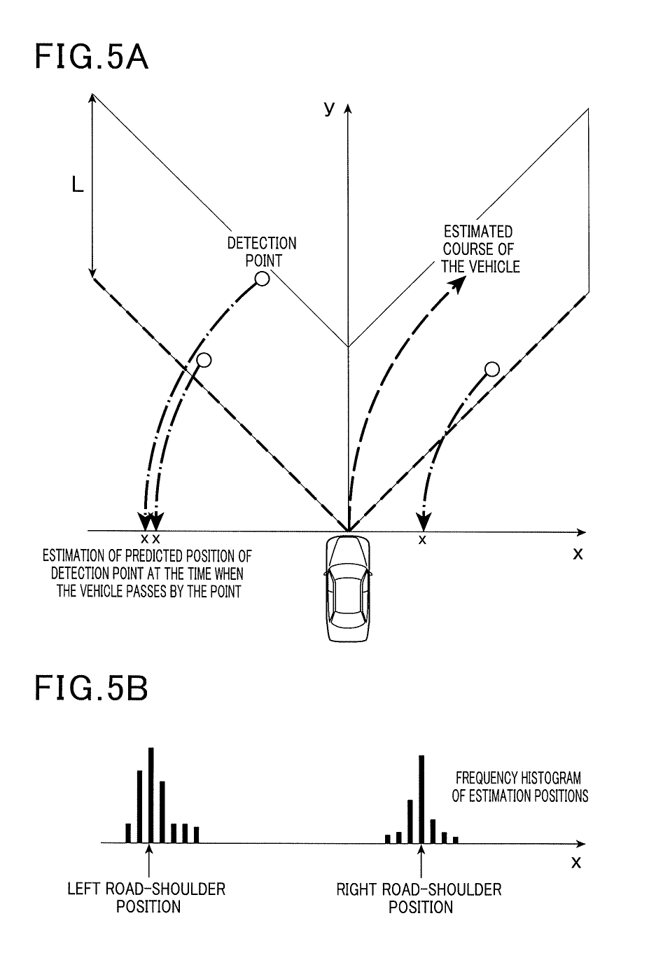

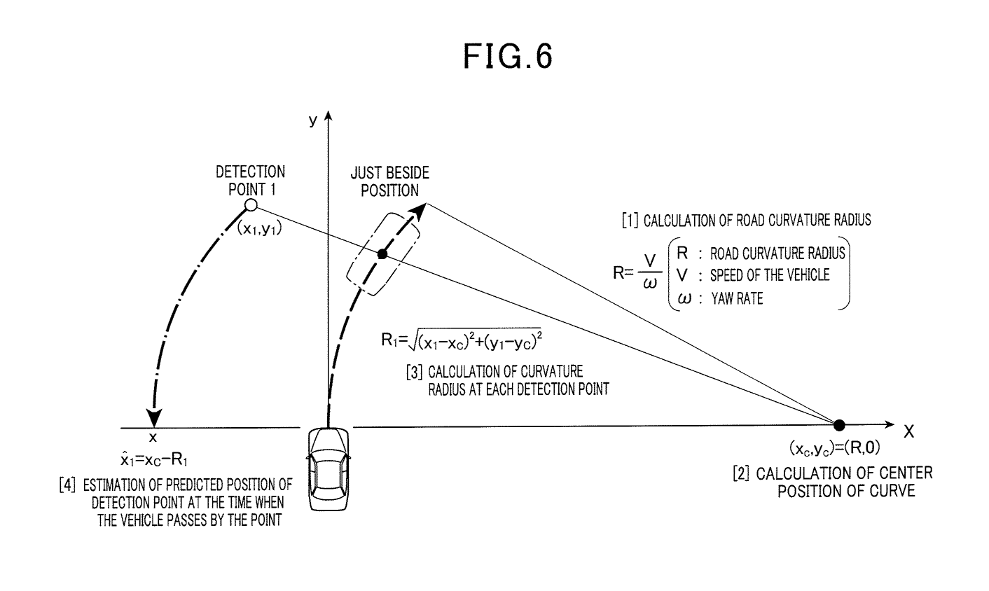

This process of estimation is explained referring to FIGS. 5A, 5B and 6. FIGS. 5A and 5B are schematic diagrams illustrating the process of estimating the position of each detection point and generating a histogram. FIG. 6 is an explanatory diagram illustrating an example of calculation in estimating the position of a detection point.

As shown in FIG. 5A, in estimating the position of each detection point, a passing position of the vehicle is calculated based on the behaviors of the vehicle. The “passing position” here refers to a distance between the position of a detection point and the position of the vehicle when the vehicle is assumed to have moved to a position right beside the detection point in question. As defined above, in the present embodiment, “the position right beside the detection point in question” is defined as a position where the mounted position of the radar 21 in the vehicle reaches a line connecting each detection position and the center of a road curvature. For example, the above calculation is performed along the procedure as specifically set forth below.

First, as shown in FIG. 6, a curvature radius R of the road whose edges are to be detected is calculated by the following Formula (3).

$$R = \frac{V}{ω} \qquad Formula ( 3 )$$

where V is a traveling speed of the vehicle and ω is a yaw rate.

Then, a center position of the curve of the road is calculated using the curvature radius R to thereby calculate a curvature radius at each detection point. In this case, when the coordinate (orthogonal coordinate) of the detection point in question is (x₁, y₁) and the coordinate of the center position of the curve is (x_{c}, y_{c})=(R, 0), the curvature radius of the detection point in question is calculated by the following Formula (4).

R₁=\sqrt{(x₁−x_{c})²+(y₁−y_{c})²} Formula (4)

Then, a position x of the detection point as viewed from the vehicle when passing the detection point is calculated by the following Formula (5).

x₁=x_{c}−R₁ Formula (5)

The position of a detection point (passing position), when it is on the right side with reference to the position of the vehicle, is calculated to be a positive value and to be a negative value when it is on the left side.

Subsequently, the histogram is updated (step S360: road-edge obtaining means, sorting means). The histogram here refers to a histogram in which individual detection points are sorted into a plurality of groups of predetermined unit distances (e.g., 1/10 m to ¼ m) according to the distance between the vehicle and each detection point when the vehicle passes right beside the detection point. Further, in the histogram, a representative value is set in each group, which indicates the distance between the group and the vehicle. A median value of the distances in the group after sorting is used as the representative value. For example, regarding a group having detection points ranging from 0 cm to 10 cm, a central value of 5 cm between 0 cm and 10 cm is used as a median value. Thus, a value that falls within a range of the distances in a group after sorting is set as a representative value of the group.

In the process of updating the histogram, it is determined which of the groups the passing position (distance when the vehicle is assumed to have moved to a position right beside the detection point) of each detection point belongs to. Then, a counter value of the group to which the detection point in question belongs is incremented.

Then, the variable i is incremented (step S370) and control returns to S340. In such a histogram generating process, a process of incrementing a counter value (the process at step S360) is performed, as mentioned above, for the group to which each range data (each detection point) belongs. As a result of the incrementing process, the histogram as shown in FIG. 5B is generated. The histogram of FIG. 5B shows a frequency distribution with the horizontal axis indicating the representative value and the vertical axis indicating the counter value of individual groups.

Referring now to the flow diagram shown in FIG. 4B, hereinafter is described a road-edge location recognizing process. In the road-edge location recognizing process, a representative value of a certain group is extracted, from each of the left and right sides of the vehicle (step S410: edge defining means). This certain group corresponds to a group having a maximum number of passing positions as a result of sorting. Then, the representative values of the left and right sides are set as respective road edges in relation to the vehicle (step S420: edge defining means). Upon completion of the present process, the road-edge location recognizing process is ended.

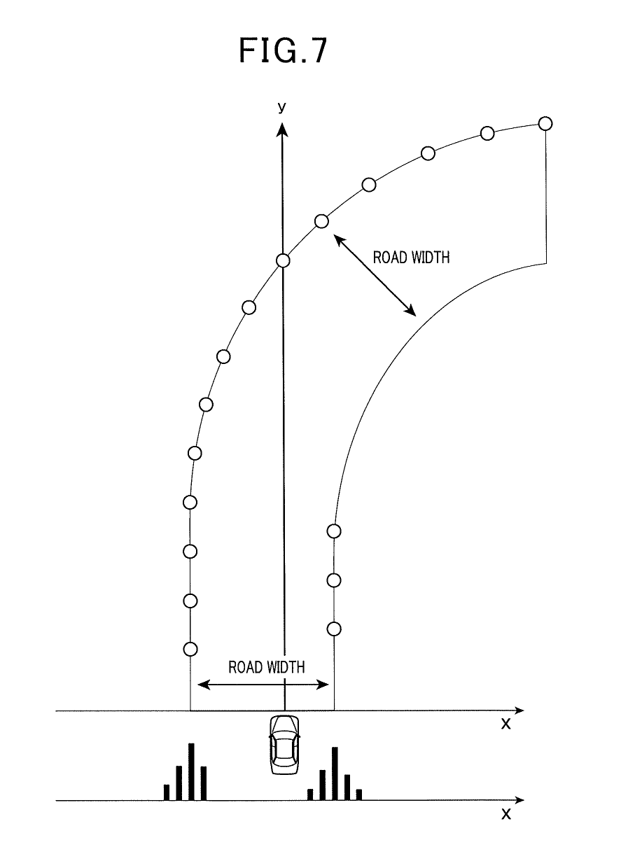

In the recognition system 1 as specifically described above, the road-edge recognition unit 10 acquires, in the road-edge location recognizing process, the results of detection of a plurality of detection points that are candidates of road edges in the forward direction of the vehicle, while also acquiring the behaviors of the vehicle. For example, the road-edge recognition unit 10 acquires detection points corresponding to the locations of the road edges as shown in FIG. 7, as well as detection points corresponding to the locations of other objects, such as buildings or other vehicles, not shown in FIG. 7, than the road edges.

Then, the road-edge recognition unit 10 calculates a passing position for each detection point based on the behaviors of the vehicle, the passing position indicating a distance between the position of a detection point and the position of the vehicle when the vehicle is assumed to have moved to the point right beside the detection point. Then, road edges are detected based on the plurality of calculated passing positions.

In this case, a histogram is generated, in which individual calculated passing positions are sorted into a plurality of groups of predetermined unit distances according to the distance between the vehicle and each detection point. In the histogram, a representative value of a group having a maximum number of passing positions as a result of sorting is set as a road edge in relation to the vehicle, regarding each of the left and right sides of the vehicle.

According to the road-edge recognition unit 10, a road edge is detected based on a plurality of passing positions. Accordingly, the accuracy of detecting a road edge is enhanced compared with a configuration in which a road edge is detected based on a sole passing position.

Further, according to the road-edge recognition unit 10, the accuracy of detecting a road edge is enhanced, irrespective of the inclusion of the detection points indicating positions of objects other than road edges. Also, this way of detecting road edges enables recognition of the road width, the position of the vehicle in relation to the road edges and the location (region) of the road in a distance. Accordingly, using these pieces of information, the vehicle is automatically controlled or drive assist is given to the driver.

Further, the road-edge recognition unit 10 sets a representative value of a certain group as a road-edge location in relation to the vehicle, regarding each of the left and right sides of the vehicle. The certain group is a group having a maximum number of passing positions as a result of sorting.

According to the road-edge recognition unit 10, since a road edge of each of the left and right sides is detected, the accuracy of detecting a road edge is more enhanced.

The radar 21 is so configured as to scan a predetermined region in the forward direction of the vehicle, while intermittently applying electromagnetic waves to the predetermined region. Then, the radar 21 is ensured to receive the reflected waves to acquire the results of detection of detection points. Meanwhile, the road-edge recognition unit 10 calculates a travel distance of the vehicle based on the behaviors of the vehicle from each time point when electromagnetic waves are applied to the predetermined region until a time point when scanning is ended. Then, the road-edge recognition unit 10 corrects each of the positions of the acquired detection points by an amount corresponding to the travel distance of the vehicle. Then, the road-edge recognition unit 10 uses the positions of the corrected detection points to define the road edges.

For example, the road-edge recognition unit 10 may be used with a laser radar which is configured to obtain detection points by scanning a predetermined region in the forward direction of the vehicle while intermittently applying electromagnetic waves to the region and by receiving the reflected waves. Being used with a laser radar having such a configuration, the road-edge recognition unit 10 is able to correct the delay time caused in the detection and therefore the accuracy of detecting a road edge is maintained.

(Modifications)

The embodiment of the present invention is not limited to the embodiment described above, but may be modified in various ways within the spirit of the present invention.

For example, a histogram has been used, in the above embodiment, in detecting each edge based on a plurality of passing positions. Alternative to this, simply a mean value of a plurality of passing positions may be used. In this case, the mean value may be of a plurality of passing positions after removal of the maximum and minimum values of the passing positions. Alternatively, a median value of a plurality of passing positions may be used.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. An apparatus for detecting at least one of right and left edges of a road on and along which a vehicle travels, the apparatus being mounted on the vehicle, the apparatus comprising:
first acquiring means for acquiring information indicative of a plurality of detection points which are given as a plurality of candidates for the edges of the road viewed forward from the vehicle;
second acquiring means for acquiring information indicative of behaviors of the vehicle;
calculating means for calculating, based on the information acquired by the first and second acquiring means, every detection point, a plurality of passing positions each indicating a position of each of the detection points to a position of the vehicle provided that the vehicle travels to a position on the road which is located right beside each of the detection points; and
road edge obtaining means for obtaining the edges of the road based on the plurality of passing positions calculated.

2. The apparatus of claim 1, wherein the road edge obtaining means comprises
sorting means for sorting the calculated passing positions into a plurality of groups of passing positions every unit distance predetermined depending on distances between the vehicle and the detection points, and
edge specifying means for specifying, as positions of the edges of the road to the vehicle, a representative passing position representative of one among the groups of passing positions, the largest number of passing positions are sorted into the representative one group of passing positions.

3. The apparatus of claim 2, wherein the edge specifying means is configured to specify, as the positions of the edges of the road, the representative passing position on each of the right and left sides to the vehicle.

4. The apparatus of claim 1, wherein
the first acquiring means is configured to acquire the information indicative of the plurality of detection points that are detected by intermittently radiating an electromagnetic wave ahead of the vehicle to scan a given spatial range ahead and viewed from the vehicle and receiving a reflected electromagnetic wave thereof,
the calculating means comprises
travel amount calculating means for calculating, every time when the electromagnetic wave is transmitted, an amount of travel of the vehicle during a given interval of time including at least a time necessary from transmitting the electromagnetic wave to receiving the reflected electromagnetic wave, based on the acquired information indicative of the behavior of the vehicle, and
position correcting means for correcting the positions of the detection points depending on the amounts of travel of the vehicle calculated by the travel amount calculating means, and
the road edge obtaining means is configured to obtain the edges of the road based on the corrected positions of the respective detection points.

5. The apparatus of claim 2, wherein
the first acquiring means is configured to acquire the information indicative of the plurality of detection points that are detected by intermittently radiating an electromagnetic wave ahead of the vehicle to scan a given spatial range ahead and viewed from the vehicle and receiving a reflected electromagnetic wave thereof,
the calculating means comprises
travel amount calculating means for calculating, every time when the electromagnetic wave is transmitted, an amount of travel of the vehicle during a given interval of time including at least a time necessary from transmitting the electromagnetic wave to receiving the reflected electromagnetic wave, based on the acquired information indicative of the behavior of the vehicle, and
position correcting means for correcting the positions of the detection points depending on the amounts of travel of the vehicle calculated by the travel amount calculating means, and
the road edge obtaining means is configured to obtain the edges of the road based on the corrected positions of the respective detection points.

6. The apparatus of claim 3, wherein
the first acquiring means is configured to acquire the information indicative of the plurality of detection points that are detected by intermittently radiating an electromagnetic wave ahead of the vehicle to scan a given spatial range ahead and viewed from the vehicle and receiving a reflected electromagnetic wave thereof,
the calculating means comprises
travel amount calculating means for calculating, every time when the electromagnetic wave is transmitted, an amount of travel of the vehicle during a given interval of time including at least a time necessary from transmitting the electromagnetic wave to receiving the reflected electromagnetic wave, based on the acquired information indicative of the behavior of the vehicle, and
position correcting means for correcting the positions of the detection points depending on the amounts of travel of the vehicle calculated by the travel amount calculating means, and
the road edge obtaining means is configured to obtain the edges of the road based on the corrected positions of the respective detection points.

7. A method of detecting at least one of right and left edges of a road on and along which a vehicle travels, the apparatus being mounted on the vehicle, the method comprising steps of:
intermittently radiating an electromagnetic wave ahead of the vehicle to scan a given spatial range ahead and viewed from the vehicle and receiving a reflected electromagnetic wave thereof;
first acquiring information indicative of a plurality of detection points which are given as a plurality of candidates for the edges of the road viewed forward from the vehicle, from the reflected electromagnetic wave;
second acquiring means for acquiring information indicative of behaviors of the vehicle;
calculating means for calculating, based on the information acquired by the first and second acquiring means, every detection point, a plurality of passing positions each indicating a position of each of the detection points to a position of the vehicle provided that the vehicle travels to a position on the road which is located right beside each of the detection points; and
road edge obtaining means for obtaining the edges of the road based on the plurality of passing positions calculated.

8. The method of claim 7, wherein the road edge obtaining step includes steps of:
sorting the calculated passing positions into a plurality of groups of passing positions every unit distance predetermined depending on distances between the vehicle and the detection points, and
edge specifying, as positions of the edges of the road to the vehicle, a representative passing position representative of one among the groups of passing positions, the largest number of passing positions are sorted into the representative one group of passing positions.

9. The method of claim 8, wherein the edge specifying means is configured to specify, as the positions of the edges of the road, the representative passing position on each of the right and left sides to the vehicle.

10. The method of clam 7, wherein
the calculating step includes
calculating, every time when the electromagnetic wave is transmitted, an amount of travel of the vehicle during a given interval of time including at least a time necessary from transmitting the electromagnetic wave to receiving the reflected electromagnetic wave, based on the acquired information indicative of the behavior of the vehicle, and
correcting the positions of the detection points depending on the amounts of travel of the vehicle calculated by the travel amount calculating step; and
the road edge obtaining step is adapted to obtain the edges of the road based on the corrected positions of the respective detection points.

11. The method of claim 8, wherein
the calculating step includes
calculating, every time when the electromagnetic wave is transmitted, an amount of travel of the vehicle during a given interval of time including at least a time necessary from transmitting the electromagnetic wave to receiving the reflected electromagnetic wave, based on the acquired information indicative of the behavior of the vehicle, and
correcting the positions of the detection points depending on the amounts of travel of the vehicle calculated by the travel amount calculating step; and
the road edge obtaining step is adapted to obtain the edges of the road based on the corrected positions of the respective detection points.

12. The method of claim 9, wherein
the calculating step includes
calculating, every time when the electromagnetic wave is transmitted, an amount of travel of the vehicle during a given interval of time including at least a time necessary from transmitting the electromagnetic wave to receiving the reflected electromagnetic wave, based on the acquired information indicative of the behavior of the vehicle, and
correcting the positions of the detection points depending on the amounts of travel of the vehicle calculated by the travel amount calculating step; and
the road edge obtaining step is adapted to obtain the edges of the road based on the corrected positions of the respective detection points.

13. A system for detecting at least one of right and left edges of a road on and along which a vehicle travels, the apparatus being mounted on the vehicle, the apparatus comprising:
a first sensor for intermittently radiating an electromagnetic wave ahead of the vehicle to scan a given spatial range ahead and viewed from the vehicle and receiving a reflected electromagnetic wave thereof;
a second sensor for sensing behaviors of the vehicle;
first acquiring means for acquiring information indicative of a plurality of detection points which are given as a plurality of candidates for the edges of the road viewed forward from the vehicle, from the reflected electromagnetic wave;
second acquiring means for acquiring information indicative of the behaviors of the vehicle, from an output of the second sensor;
calculating means for calculating, based on the information acquired by the first and second acquiring means, every detection point, a plurality of passing positions each indicating a position of each of the detection points to a position of the vehicle provided that the vehicle travels to a position on the road which is located right beside each of the detection points; and
road edge obtaining means for obtaining the edges of the road based on the plurality of passing positions calculated.
